(19) United States
(12) Patent Application Publication
(10) Pub. No.: US 2026/0241657 A1
(43) Pub. Date: Aug. 20, 2026

(54) A SYSTEM FOR VISCOUS SLURRY SEPARATION AND A PROCESS THEREOF

(71) Applicant: Shreepad HEGDE, Hyderabad (IN)

(72) Inventor: Shreepad HEGDE, Hyderabad (IN)

(21) Appl. No.: 19/159,475

(22) PCT Filed: Feb. 24, 2024
(86) PCT No.: PCT/IB2024/051786

§ 371 Date: Aug. 25, 2025

(30) Foreign Application Priority Data
Feb. 24, 2023 (IN) 202241048112

(51) Int. Cl. B30B 9/14; B30B 9/12; B30B 9/26

(52) U.S. Cl. CPC B30B 9/14; B30B 9/121; B30B 9/127; B30B 9/26

(57) ABSTRACT

The present invention relates to a system and process for viscous slurry separation the system comprises a rotating screw mounted on a shaft, a plurality of barrels housing the rotating screw and shaft, at least one filter media positioned at the bottom side of the barrels, a slurry inlet hopper for introducing slurry into the system, a mother liquor collection tank positioned below the barrels for collecting separated liquid and mechanisms for introducing compressed gas within the barrels at predetermined stages to supplement the separation force.

### FIELD OF THE INVENTION

Embodiments of the present invention relate to technologies for slurry treatment using screw and barrel filter of organic and inorganic materials and more particularly to a system for viscous slurry separation and a process thereof.

### BACKGROUND

A slurry is a mixture of denser solids suspended in liquid, like water or any other solvent. Various types of slurry are generated during the process in chemical, pharmaceutical, food, paper and fertilizer industries. The solids are then separated from the liquid. There are many types' liquid solid separation processes. Separated liquid is called as filtrate and solid is called as residue. Low viscous slurry is easy to separate. In such cases vacuum filters or agitated nutsche filter are used. But when slurry is highly viscous, or solid percentage is high, they are very difficult to separate. Very high separation force is required to separate solids from liquid. In such cases the equipment like centrifuge or filter press are used. Most of the machines available and described above are batch processing machines. The slurry is always processed in batches of predefined quantity. Most of the cases the separation force available depends on compressed air or vacuum availability. In either case there is a limitation of the force which can be generated; the vacuum maximum possible is 1 bar, the compressor is limited by the energy requirement and safety concerns. In most of these machines, the wet cake comes out like big lumps. Separate equipment is required to delump the cakes.

Therefore, there is a need in the art for a system for viscous slurry separation and a process thereof with a new design and method in which filtration is done with high separation force and in continuous process. There exists a scope for new approach which can operate on continuous basis.

### SUMMARY

An object of the present invention is to provide a system for viscous slurry separation.

Another object of the present invention is to provide method for viscous slurry separation.

Yet another object of the present invention is to provide the method wherein filtration is done in continuous process.

Another object of present invention is to provide the method and system for high separation energy under containment.

An another object of the present invention is to provide the method and system for breaking the lumps and making it smaller particles (de-agglomeration).

According to one aspect of the invention, there is provided a system for viscous slurry separation, comprises a rotating screws mounted on a shaft, a plurality of barrels housing the rotating screw and shaft, configured to facilitate the sequential processing of slurry through designated separation zones; at least one filter media positioned at the bottom side of the barrels, enabling separation of liquid from solid components of the slurry, with the barrels adapted to support the filter media for effective filtration; a slurry inlet hopper for introducing slurry into the system; a mother liquor collection tank positioned below the barrels for collecting separated liquid; mechanisms for introducing compressed gas within the barrels at predetermined stages to supplement the separation force, facilitating the expulsion of liquid through the filter media.

In accordance with an embodiment of the present invention, the screw features a variable pitch capable of progressive reduction, increase, or remaining constant, and the shaft may adopt configurations including splined, hexagonal, or other shapes, with the possibility of the screw being an integral part of the shaft.

In accordance with an embodiment of the present invention, the rotating screw includes a segmental screw with a changing pitch and profile, mounted on the shaft.

In accordance with an embodiment of the present invention, the mother liquor collection tank is further connected to a vacuum pump, such that the application of vacuum assists in the filtration process.

In accordance with an embodiment of the present invention, the rotating screw conveys the slurry through the barrels, sequentially moving through zones designed for dewatering, squeezing, and decompression of the slurry, facilitating the separation of solid and liquid components, and discharging a wet powder.

According to a second aspect of the invention, there is provided a process for viscous slurry separation, the process comprises step of introducing slurry into a separation system via a slurry inlet mechanism, where the slurry is prepared for processing; conveying the slurry through a plurality of barrels using a rotating screw mounted on a shaft, where the screw applies variable pressure and motion to facilitate separation; filtering the slurry by passing it through at least one filter media positioned at the bottom side of the barrels, separating the liquid component from the solid component of the slurry; collecting the separated liquid component in a mother liquor collection tank positioned below the barrels; and expelling the solid component from the barrels after separation, resulting in the discharge of a processed solid material.

In accordance with an embodiment of the present invention, adjust the pitch of the rotating screw during the conveying step to modulate pressure within the barrels for optimized dewatering. The screw pitch is adjusted to create a dewatering zone where increased pressure forces liquid through the filter media into the mother liquor collection tank, and the filter media is selected based on the barrel configuration to be either flat, circular, or semi-circular.

In accordance with an embodiment of the present invention, after the dewatering zone, the slurry is conveyed into a squeezing zone by further reducing the screw pitch to increase pressure on the slurry, facilitating the extraction of remaining filtrate into the mother liquor collection tank and leaving behind a wet cake within the barrel.

In accordance with an embodiment of the present invention, move the wet cake into a decompression zone by adjusting the screw to an increased pitch, thereby decompressing and delumping the wet cake into a wet powder, which is then expelled through a discharge mechanism.

In accordance with an embodiment of the present invention, integrate a washing stage after the decompression zone, wherein wash liquid is introduced to process the decompressed wet cake, creating a reconstituted slurry that is subjected to subsequent dewatering, squeezing, and decompression steps to achieve a purified wet powder

### BRIEF DESCRIPTION OF THE DRAWINGS

So that the manner in which the above recited features of the present invention can be understood in detail, a more particular to the description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, the invention may admit to other equally effective embodiments. These and other features, benefits and advantages of the present invention will become apparent by reference to the following figures, with reference numbers referring to like structures across the drawings, wherein:

FIG. 1 illustrates an exemplary system for viscous slurry separation, in accordance with an embodiment of the present invention.

FIG. 2 illustrates a top cross-sectional and front cross-sectional view of the system, in accordance with an embodiment of the present invention.

FIG. 3 illustrates an exemplary configuration of rotating screw mechanism, in accordance with an embodiment of the present invention.

FIG. 4 illustrates an exemplary circular filter media, in accordance with an embodiment of the present invention.

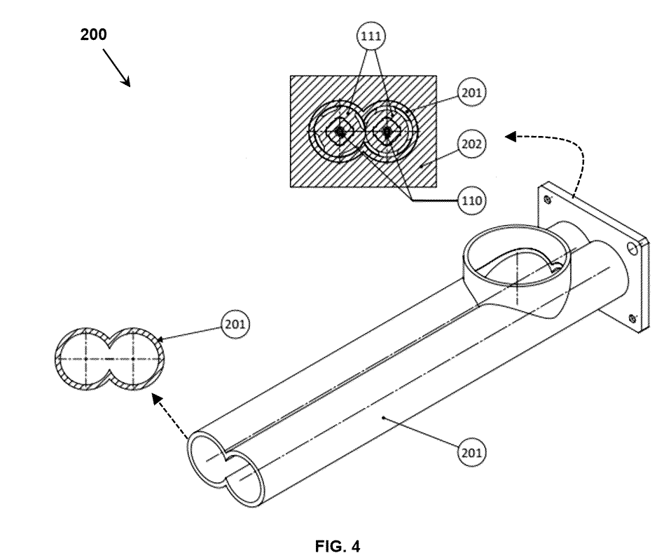

FIG. 5 illustrates a flowchart of the process for viscous slurry separation, in accordance with an embodiment of the present invention.

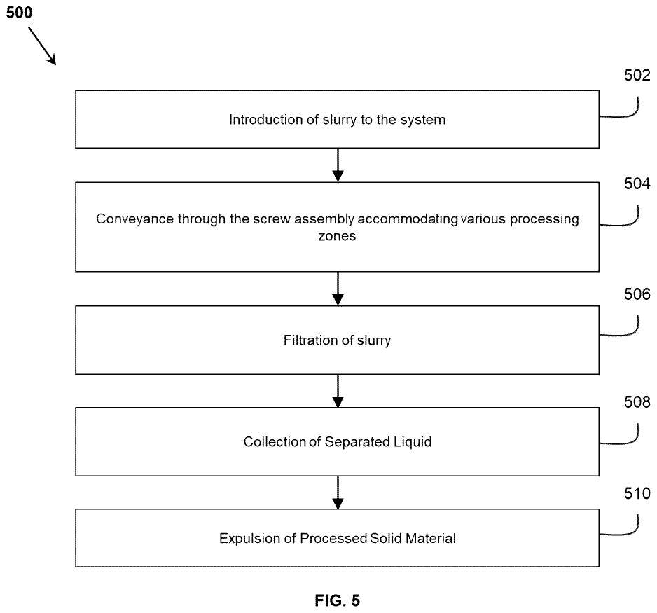

### DETAILED DESCRIPTION

While the present invention is described herein by way of example using embodiments, those skilled in the art will recognize that the invention is not limited to the embodiments described herein. It should be understood that the description herein is not intended to limit the invention to the particular form disclosed, but on the contrary, the invention is to cover all modification/s, equivalent/s and alternative/s falling within the scope of the present invention. The headings used herein are for organizational purposes only and are not meant to be used to limit the scope of the description or the claim. As used throughout this description, the word “may” be used in a permissive sense (i.e., meaning having the potential to), rather than the mandatory sense (i.e., meaning must). Further, the words “a” or “an” means “at least one” unless otherwise mentioned. Furthermore, the terminology and phraseology used herein is solely used for descriptive purposes and should not be construed as limiting in scope. Language such as “including”, “comprising”, “having”, “containing”, or “involving” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the likes are included in the specification solely for the purpose of providing a context for the present invention. It is not suggested or represented that any or all these matters form part of the prior art base or were common general knowledge in the field relevant to the present invention.

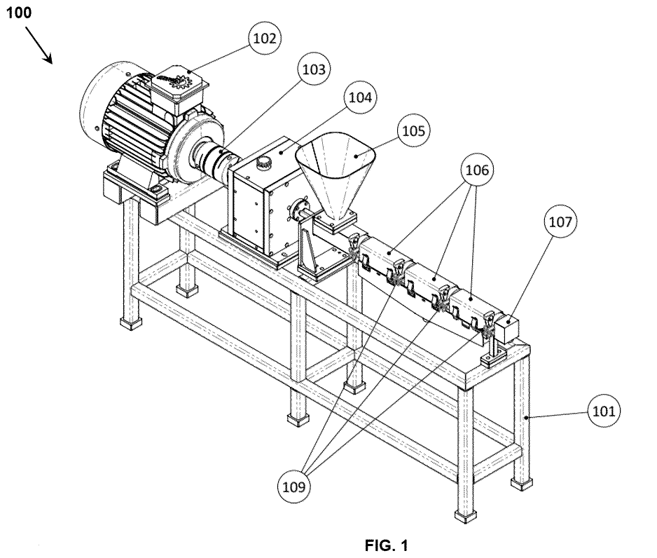

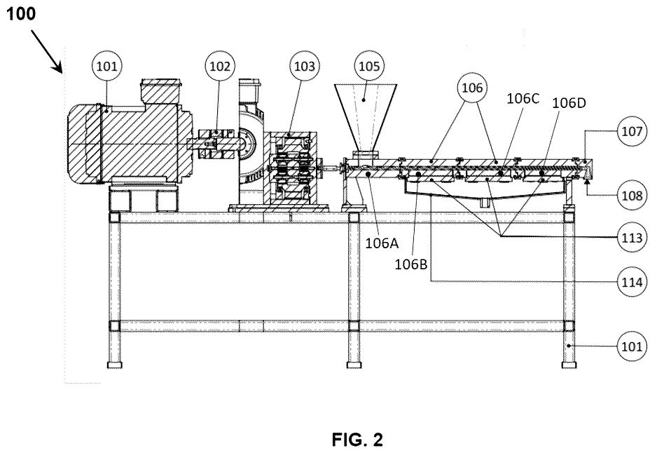

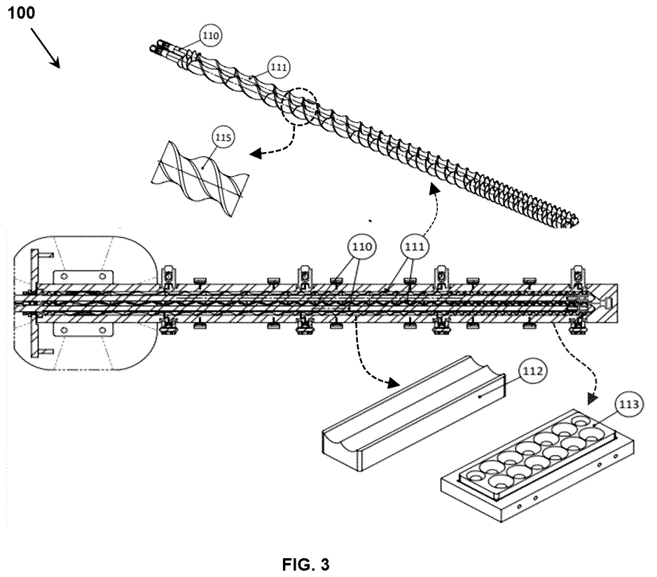

FIG. 1-3 illustrate a system (100) for viscous slurry separation, in accordance with an embodiment of the present invention. FIG. 1 illustrates a perspective view of the system (100), FIG. 2 illustrates a top cross-sectional and front cross-sectional view of the system (100) and FIG. 3 illustrates an exemplary configuration of rotating screw mechanism. The system (100) comprises of a rotating screw (111) mounted on a shaft (110), a plurality of barrels (106), at least one filter media, a slurry inlet hopper (105), a mother liquor collection tank (114), mechanisms for introducing compressed gas within the barrels (106) at predetermined stages to supplement the separation force.

Central to the invention is the distinctive screw (111) and shaft (110) assembly, wherein the screw may either be an independent component or integrally carved from the shaft itself, a design choice that allows for flexibility in operation and maintenance. The variable pitch of the screw (111), as shown in FIG. 3, capable of progressive reduction, increase, or maintenance at a constant level, caters to the nuanced needs of different slurry separation processes. The screw may be single long or segmental type. The segmented screw may be assembled over a long shaft. The length of the screw (segmented screw) may be divided into different zones. In the present illustrated invention, the process may be completed in stages may be, but not limited to, including feeding, filtration, squeezing, dewatering, washing, and breaking the lump and discharge. Depending on the type of the application, the zone and screw segments may be of different design, different shape, different size, different length, different screw pitch and different profile. Each zone may also have one or more screw segments of same type depending on the requirement.

The profile of the screw is selected based on the application like viscosity, sticky or free flowing nature, type of solid like amourphous or crystalline or fibrous etc. Profile of the screw elements may be selected based on what it has to do like filtration, dewatering, squeezing or de-agglomeration (delumping) of the wet cake etc. The screw diameter and the barrel internal diameter can also be progressively reducing if required.

The system includes a plurality of barrels (106), the number of which is adaptable based on the specific requirements of the application at hand, housing the screw (111) and shaft (110) assembly. The barrels are key to the staged separation process, guiding the slurry through various zones designed for efficient separation. Positioned at the bottom side of the barrels is the filter media (112). The system is designed to accommodate various types of filter media, such as flat (112), circular (201), as shown in FIG. 2, and semi-circular configurations, supported accordingly by either perforated (202) or solid (106) barrels, depending on the selected media type.

The barrel may be made in single or multiple segments. Multiple barrel may be connected with quick release coupling. Different types of barrel and filter media design is envisaged in the slurry separation device.

For example
1. The bottom of the some of the segments of the barrel may be provided with flat filter media (112) (upper side curvy to match the screw profile and other side flat) and supported by perforated plate. The size and shape of the filter media will depend the filtration area required.
2. In another option, the barrel is made up of two concentric pipes. Inner pipe is made up of filter media, typically of sintered filter or any other filter media. Outer pipe of the barrel is called secondary barrel is made up of solid/perforated material and acts as a backup for sintered filter (filter media) to withstand pressure. The secondary barrel also acts as a drain collection zone. The filtrate is oozing out of the primary barrel i.e., sintered filter or filter media is collected in the secondary barrel and then drained to mother liquor collection tank.

Slurry introduction into the system is facilitated through a slurry inlet hopper (105) which act as a feeding zone, however, with an alternative configuration allowing for direct connection to a slurry inlet pump, eliminating the need for a hopper. Below the barrels, a mother liquor collection tank (114) is strategically placed to collect the separated liquid, with an optional connection to a vacuum pump to maintain the vacuum pressure inside tank (114), not illustrated in the figures. The application of a vacuum enhances the filtration efficiency, acting as an additional force to expedite the separation process. The screw (111) will compress the slurry and push the liquid out from the barrels (106) and at the same time vacuum will pull the liquid out. Vacuum will act as an additional separation force Moreover, the system incorporates mechanisms for the application of compressed gas at various stages, further enhancing the separation efficacy by pushing the liquid through the filter media.

The slurry, once introduced, is conveyed through the barrels by the rotating screw (111), moving sequentially through designated zones each tailored for a specific function in the separation process. The dewatering zone leverages the screw's reduced pitch to compress the slurry and expel the liquid through the filter media, while the squeezing zone applies further pressure to extract additional liquid, leaving behind a wet cake. The wet cake is then processed in the decompression zone, where an increased screw pitch facilitates its decompression and delumping into a wet powder, subsequently discharged from the system.

An optional wash zone can be integrated into the system for applications requiring further purification of the wet cake, removing residual filtrate through additional washing and separation stages. This flexibility, alongside the system's capacity for customization in screw pitch, filter media type, and the inclusion of vacuum and compressed gas applications, underscores the invention's adaptability to a wide range of slurry separation requirements.

As explained previously, in certain cases washing may be required to remove the traces of the filtrate retained in the wet cake. In such cases wash zone is added the after decompression, followed by dewatering, squeezing and decompression zones. After decompression wash liquid is pumped into wash zone through an additional nozzle. The incoming decompressed wet cake is washed in the wash zone and a slurry is created. Again, the reconstituted wet slurry passes through subsequent dewatering, squeezing and decompression zone to get the wet powder in the end.

Some exemplary materials may be used in the system, but not limited to, are SS316, alloys and non-metal contact parts and for non-contact parts.

In accordance with an exemplary embodiment of the present invention, the process can be classified in zones as feeding zone, dewatering zone, squeezing zone, decompression zone, delumping zone and discharge/collection zone. In some cases it may continue further processing with washing, secondary dewatering, secondary squeezing, and secondary delumping zone and then to discharge zone.

In accordance with an embodiment of the present invention, the operating condition may include pressure in range of, but not limited to, 1-100 bar in filtration zone, and temperature in range of, but not limited to, 0-80° C. in Filtration zone.

FIG. 2 illustrates a process for viscous slurry separation. The process, as depicted, is a sequence of interrelated steps in the solid-liquid separation:

Introduction of slurry to the system (Step 502): The process begins with feeding slurry into a slurry inlet hopper (105), which can alternatively be directly connected to a slurry inlet pump, bypassing the need for a slurry inlet hopper. This step ensures the initial handling and introduction of the slurry into the equipment or system for subsequent processing.

Conveyance through the screw assembly (Step 504): The slurry is then transferred into the interstitial gap between the rotating screw (111) and the inner surface of the barrel (106). The screw (111), integral to or mounted on the shaft (110), is rotated by a motor and gearbox arrangement, effectively moving the slurry forward through the equipment. The screw (111) and shaft (110) assembly is central to the operation, with the segmental screw (115) featuring a changing pitch and profile to accommodate various processing zones.

Filtration of slurry (Step 506): The core separation occurs as the slurry is filtered through at least one filter media located at the bottom side of the barrels (106). This step effectively separates the liquid component from the solid component of the slurry. The type of filter media (112, 201) and the configuration of the barrels (solid 106 or perforated 202) are selected based on the specific requirements of the slurry being processed.

Collection of separated liquid (Step 508): The liquid component, now separated from the slurry, is collected in a mother liquor collection tank (114) situated below the barrels (106). This step ensures that the filtrate is efficiently removed from the apparatus, allowing for further processing or disposal as required.

Expulsion of processed solid material (Step 510): Following the separation, the solid component is expelled from the barrels (106), resulting in the discharge of processed solid material. This material, which can range from a wet cake to a wet powder depending on the specific processing parameters and the nature of the slurry, is then ready for further processing or disposal.

To enhance the separation efficiency, the pitch of the rotating screw (111) can be adjusted. This allows for optimization based on the viscosity and composition of the slurry, ensuring that the mechanical forces applied are precisely tailored to the separation task at hand. Further, for improved efficiency in liquid separation, a vacuum can be applied to the mother liquor collection tank (114). This aids in drawing the liquid through the filter media, facilitating faster and more effective separation.

At predetermined stages within the barrels (106), compressed gas can be introduced. This serves as an additional force, aiding in the expulsion of the liquid component through the filter media and enhancing the overall efficiency of the separation process.

As the slurry advances, it enters the dewatering zone where the screw pitch reduction leads to increased pressure on the slurry, forcing the liquid (filtrate) through the selected filter media (112, 201) and into a mother liquor collection tank (114) positioned below. The screw pitch may vary, being either progressively reduced, increased, or constant, to optimize the dewatering process. The filter media can be of different designs, including flat, circular, or semi-circular, supported accordingly by the barrel configuration (solid 106 or perforated 202).

Following dewatering, the thicker slurry is pushed into the squeezing zone by the rotating screw (111), where further pitch reduction increases the pressure exerted on the slurry. This high-pressure environment facilitates the extraction of remaining filtrate, which drains into the mother liquor collection tank (114), leaving behind a wet cake within the barrel (106).

The process continues as the screw (111) moves the wet cake into the decompression zone. Here, an increased screw pitch and suitable screw profile (115) aid in decompressing and delumping the wet cake into a wet powder. This wet powder is then discharged through a discharge piece (107) and exits the equipment via a discharge nozzle (108).

In instances where residual filtrate removal is necessary, a wash zone, not shown in figure, is incorporated following the decompression zone. Wash liquid is introduced through an additional nozzle, creating a slurry from the decompressed wet cake. This reconstituted slurry undergoes subsequent dewatering, squeezing, and decompression to yield the final wet powder.

In an embodiment of the present invention, the plurality of barrels of the system, each designated for a specific phase of the separation process, ensuring a systematic and efficient separation of the slurry into its constituent components. For instance, the system comprises four main barrels positioned sequentially to facilitate the transition of the slurry through various stages of processing, from the introduction of the slurry to the final expulsion of the separated components, as shown in FIG. 2.

The first barrel (106A), positioned directly below the slurry feeding hopper, serves as the conveying or feeding zone. At this stage the even distribution and forward movement of the slurry into the system is carried out. The rotating screw (111) within this barrel ensures the slurry received is evenly conveyed to the next stage, without premature dewatering or separation, maintaining a consistent flow and preventing any blockages that might disrupt the separation process.

The second barrel (106B) in the sequence is designated as the dewatering zone to initiate the separation of the liquid phase from the solid constituents of the slurry. The rotating screw (111) within this barrel features a modified pitch designed to create an increased pressure environment conducive to the extraction of liquid. This stage effectively reduces the moisture content of the slurry, preparing it for further compression and separation in the subsequent barrels.

Following the dewatering zone, the slurry advances to the third barrel (106C), identified as the squeezing zone. The configuration of the screw (111) within this barrel is further optimized to apply additional pressure on the already dewatered slurry. This increased compression facilitates the removal of residual liquid content, ensuring a more thorough dewatering process. The squeezing zone is critical for maximizing the extraction of liquid, resulting in a significantly denser slurry composition, aptly termed as a “wet cake,” which is then ready for the next phase of separation.

The final barrel (106D) in the sequence acts as the decompression and delumping zone. Within this barrel, the pitch of the screw (111) is adjusted to allow for the expansion and breaking apart of the wet cake. This decompression is essential for transforming the compressed slurry into a manageable and processable form. The action of the screw in this zone ensures that any lumps formed during the squeezing phase are broken down, resulting in a uniform wet powder. This wet powder is then expelled from the system through discharge nozzle (108), ready for further processing or use as a finished product.

Each barrel (106) in the system is specifically designed and configured to perform its designated function within the overall separation process. This systematic approach ensures that the slurry undergoes a comprehensive and efficient separation process, transitioning smoothly from one phase to the next, ultimately achieving a high-quality separation of the solid and liquid components. The present invention has various advantages. The present invention is suitable for viscous slurry continuous separation for pharmaceutical, food, pesticide and chemical slurry which require high separation force. Through the present invention, continuous process to achieve higher throughput, reduce losses and energy consumption. Continuous process reduces the equipment overall size to large extent. The energy consumption will also be less in case of continuous process. Efficiency of the system can also be higher in case of continuous process. Losses in continuous operation is lower higher than the batch manufacturing operation.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing the broadest scope, consistent with the principles and the novel and inventive features disclosed or suggested herein. Accordingly, the invention is anticipated to hold on to all other such alternatives, modifications, and variations that fall within the scope of the present invention and appended claims.

1. A system for viscous slurry separation, comprising:
a slurry inlet hopper for introducing slurry into the system;
a rotating screw mounted on a shaft;
a plurality of barrels housing the rotating screw and shaft, configured to facilitate the sequential processing of slurry through designated separation zones;
at least one filter media positioned at a bottom side of the barrels, enabling separation of liquid from solid components of the slurry; and
a mother liquor collection tank positioned below the barrels for collecting separated liquid.

2. The system as claimed in of claim 1, wherein the screw has a variable pitch capable of progressive reduction, increase, or remaining constant, and the shaft adopts configurations including splined, hexagonal, or other shapes, with optionally being an integral part of the shaft.

3. The system of claim 1, wherein the rotating screw includes a segmental screw with a changing pitch and profile, mounted on the shaft.

4. The system of claim 1, wherein the mother liquor collection tank is further connected to a vacuum pump, a vacuum assisting in the filtration process.

5. The system of claim 1, wherein the rotating screw conveys the slurry through the barrels, sequentially moving through zones designed for dewatering, squeezing, and decompression of the slurry, facilitating the separation of solid and liquid components, and discharging a wet powder.

6. A method for viscous slurry separation, comprising:
introducing slurry into a separation apparatus via a slurry inlet mechanism preparing the slurry for processing;
conveying the slurry through a plurality of barrels using a rotating screw mounted on a shaft, where the screw applies variable pressure and motion to facilitate separation;
filtering the slurry by passing it through at least one filter media positioned at a bottom side of the barrels separating the liquid component from the solid component of the slurry;
collecting the separated liquid component in a mother liquor collection tank positioned below the barrels; and
expelling the solid component from the barrels after separation, resulting in the discharge of a processed solid material.
Wherein the plurality of barrels are configured to facilitate the sequential processing of slurry through designated separation zones.

7. The method of claim 6, further comprising adjusting the pitch of the rotating screw during the conveying step to modulate pressure within the barrels for optimized dewatering;
wherein the screw pitch is adjusted to create a dewatering zone where increased pressure forces liquid through the filter media into the mother liquor collection tank, and the filter media is selected based on the barrel configuration to be either flat, circular, or semi-circular.

8. The method as claimed in claim 7, wherein after the dewatering zone, the slurry is conveyed into a squeezing zone by further reducing the screw pitch to increase pressure on the slurry, facilitating the extraction of remaining filtrate into the mother liquor collection tank and leaving behind a wet cake within the barrel.

9. The method of claim 8, further comprising moving the wet cake into a decompression zone by adjusting the screw to an increased pitch, thereby decompressing and delumping the wet cake into a wet powder, which is then discharged from the system.

10. The method of claim 8, further comprising integrating a washing stage after the decompression zone, wherein wash liquid is introduced to process the decompressed wet cake, creating a reconstituted slurry that is subjected to subsequent dewatering, squeezing, and decompression steps to achieve a purified wet powder.
